(19) United States
(12) Patent Application Publication
(10) Pub. No.: US 2025/0312680 A1
(43) Pub. Date: Oct. 9, 2025

(54) METHODS, SYSTEMS, AND DEVICES FOR CAPTURING VIDEO CONTENT ASSOCIATED WITH PERFORMING AN ATHLETIC SKILL AND DETERMINING BIOMECHANIC ADJUSTMENTS FOR PERFORMING THE ATHLETIC SKILL

(71) Applicant: ATHLETIQ, LLC, Lubbock, TX (US)

(72) Inventor: Matthew Mooney, Wauconda, IL (US)

(73) Assignee: ATHLETIQ, LLC, Lubbock, TX (US)

(21) Appl. No.: 19/241,708

(22) Filed: Jun. 18, 2025

Related U.S. Application Data
(63) Continuation-in-part of application No. PCT/US2023/084860, filed on Dec. 19, 2023.
(63) Continuation-in-part of application No. PCT/US2024/041481, filed on Aug. 8, 2024.
(60) Provisional application No. 63/476,294, filed on Dec. 20, 2022.
(60) Provisional application No. 63/518,480, filed on Aug. 9, 2023.

(51) Int. Cl. A63B 71/06; A63B 24/00; G06V 20/40; G06V 40/10; G06V 40/20

(52) U.S. Cl. CPC A63B 71/0622; A63B 24/0006; A63B 24/0062; G06V 20/42; G06V 40/10; G06V 40/23; A63B 2024/0009; A63B 2024/0071; A63B 2220/806; A63B 2243/0037

(57) ABSTRACT

Aspects of the subject disclosure may include, for example, obtaining current video content of a player repeatedly performing a physical skill, analyzing the current video content based on previous video content, the previous video content comprises other video content of the player repeatedly performing the physical skill, determining biomechanic metrics of the player performing the physical skill based on the analysis, and determining each biomechanic metric of a portion of the biomechanic metrics does not satisfy a respective biomechanic metric success rate. Further embodiments include generating a first image of the player performing the physical skill from the current video content, generating a second image of the player performing the physical skill from the previous video content, and presenting the first image and the second image simultaneously and indicating the portion of the biomechanics that did not satisfy the respective biomechanic metric success rate. Other embodiments are disclosed.

### CROSS-REFERENCE TO RELATED APPLICATION(S)

The present application claims priority to and is a continuation in part of Patent Cooperation Treaty Application No. PCT/US2023/084860, filed Dec. 19, 2023, which claims the benefit of priority to U.S. Provisional Application No. 63/476,294, filed Dec. 20, 2022. Further, the present application claims priority to and is a continuation in part of Patent Cooperation Treaty Application No. PCT/US2024/041481, filed Aug. 8, 2024, which claims the benefit of priority to U.S. Provisional Application No. 63/518,480, filed Aug. 9, 2023. All sections of the aforementioned application(s) and/or patent(s) are incorporated herein by reference in their entirety.

### FIELD OF THE DISCLOSURE

The subject disclosure relates to methods, systems, and devices for capturing video content associated with performing an athletic skill and determining biomechanic adjustments for performing the athletic skill based on correlation of biomechanics to success rates.

### BACKGROUND

In athletic performance and analytics, the ability to accurately assess and improve an athlete's skills can be challenging. Traditional methods of evaluating athletic performance, particularly in sports like basketball, often rely on subjective observations and manual tracking of metrics such as balance, alignment, movement, footwork, and other biomechanics. These methods can be inconsistent and fail to provide the comprehensive feedback necessary for athletes to refine their skills effectively. Moreover, existing technologies that attempt to automate this process often lack the precision and adaptability required to cater to the specific biomechanics of individual athletes. Further, the current state of the art falls short in providing real-time, actionable insights that can be tailored to the specific needs of each athlete. This limitation hinders athletes from maximizing their training sessions or gameplay and achieving optimal performance.

### BRIEF DESCRIPTION OF THE DRAWINGS

Reference will now be made to the accompanying drawings, which are not necessarily drawn to scale, and wherein:

FIG. 1, FIG. 2A, FIG. 2B, FIG. 3, and FIG. 4 are block diagrams illustrating exemplary, non-limiting embodiments of a system to determine the biomechanics of a player to perform a skill in accordance with various aspects described herein.

FIG. 5 depicts an illustrative embodiment of a method in accordance with various aspects described herein.

FIG. 6A, FIG. 6B, FIG. 7, FIG. 8, and FIG. 9 are block diagrams illustrating exemplary, non-limiting embodiments of a system to determine the biomechanics of a player to perform a skill in accordance with various aspects described herein.

FIG. 10 is a block diagram of an example, non-limiting embodiment of a computing environment in accordance with various aspects described herein.

### DETAILED DESCRIPTION

The subject disclosure describes, among other things, illustrative embodiments for obtaining video content of a player repeatedly performing a physical skill during a first time period resulting in current video content, analyzing the current video content utilizing an AI software application based on previous video content resulting in an analysis, where the previous video content comprises other video content of the player repeatedly performing the physical skill during a second time period, and where the second time period is prior to the first time period. A group of biomechanic metrics can then be determined, which are associated with the player performing the physical skill based on the analysis utilizing the AI software application resulting in a first determination. Further embodiments include, based on the first determination, determining each biomechanic metric of a portion of the group of biomechanic metrics does not satisfy a respective biomechanic metric success rate from a group of respective biomechanic metric success rates resulting in a second determination, based on the second determination, generating a first image of the player performing the physical skill from the current video content; based on the second determination, generating a second image of the player performing the physical skill from the previous video content, and presenting the first image and the second image simultaneously on the device with an indication of the portion of the group of biomechanics that did not satisfy the respective biomechanic metric success rate. Some embodiments determine the success rate of each biomechanic metric, then comparing each biomechanic metric to the player's average success rate for the performing the physical skill then providing feedback/actionable insights based on the difference between each biomechanic metric's success rate and the player's overall success rate in performing the physical skill Further embodiments indicate which biomechanics led to higher success rates, making the player aware of the difference and providing actionable insights for improvement. Other embodiments are described in the subject disclosure.

One or more aspects of the subject disclosure include a device. comprising a processing system including a processor, and a memory that stores executable instructions that, when executed by the processing system, facilitate performance of operations. The operations can comprise obtaining video content of a player repeatedly performing a physical skill during a first time period resulting in current video content, analyzing the current video content utilizing an AI software application based on previous video content resulting in an analysis, the previous video content comprises other video content of the player repeatedly performing the physical skill during a second time period, and the second time period is prior to the first time period. Further operations can comprise determining a group of biomechanic metrics associated with the player performing the physical skill based on the analysis utilizing the AI software application resulting in a first determination, based on the first determination, determining each biomechanic metric of a portion of the group of biomechanic metrics does not satisfy a respective biomechanic metric success rate from a group of respective biomechanic metric success rates resulting in a second determination, based on the second determination, generating a first image of the player performing the physical skill from the current video content, based on the second determination, generating a second image of the player performing the physical skill from the previous video content, and presenting the first image and the second image simultaneously on the device with an indication of the portion of the group of biomechanics that did not satisfy the respective biomechanic metric success rate.

One or more aspects of the subject disclosure include a non-transitory, machine-readable storage device, comprising executable instructions that, when executed by a processing system including a processor, facilitate performance of operations. The operations can comprise obtaining video content of a player repeatedly performing a physical skill during a first time period resulting in current video content, analyzing the current video content utilizing an AI software application based on previous video content resulting in an analysis, the previous video content comprises other video content of the player repeatedly performing the physical skill during a second time period, the second time period is prior to the first time period, and determining a group of biomechanic metrics associated with the player performing the physical skill based on the analysis utilizing the AI software application resulting in a first determination. Further operations can comprise based on the first determination, determining each biomechanic metric of a portion of the group of biomechanic metrics does not satisfy a respective biomechanic metric success rate from a group of respective biomechanic metric success rates resulting in a second determination, and based on the second determination, generating a first image of the player performing the physical skill from the current video content. Additional operations can comprise based on the second determination, generating a second image of the player performing the physical skill from the previous video content, and providing the first image and the second image to a computing device over a communication network, the computing device presents the first image and the second image simultaneously on the computing device with an indication of the portion of the group of biomechanics that did not satisfy the respective biomechanic metric success rate.

One or more aspects of the subject disclosure include a method. The method can comprise obtaining, by a processing system including a processor, video content of a player repeatedly performing a physical skill during a first time period resulting in current video content utilizing a group of camera sensors, each camera sensor of the group of camera sensors are oriented in a respective first position, and determining, by the processing system, that a group of biomechanic metrics cannot be determined from a portion of the current video content utilizing an AI software application resulting in a first determination. Further, the method can comprise based on the first determination, adjusting, by the processing system, a portion of the group of camera sensors from the respective first position to a respective second position, analyzing, by the processing system, the current video content utilizing the AI software application based on previous video content resulting in an analysis, the previous video content comprises other video content of the player repeatedly performing the physical skill during a second time period, the second time period is prior to the first time period, and determining, by the processing system, the group of biomechanic metrics associated with the player performing the physical skill based on the analysis utilizing the AI software application resulting in a second determination. In addition, the method can comprise based on the second determination, determining, by the processing system, each biomechanic metric of a portion of the group of biomechanic metrics does not satisfy a respective biomechanic metric success rate from a group of respective biomechanic metric success rates resulting in a third determination, based on the third determination, generating, by the processing system, a first image of the player performing the physical skill from the current video content, based on the third determination, generating, by the processing system, a second image of the player performing the physical skill from the previous video content, and presenting, by the processing system, the first image and the second image simultaneously on the processing system with an indication of the portion of the group of biomechanics that did not satisfy the respective biomechanic metric success rate.

In the area of athletic performance, repeatedly and consistently performing an athletic skill is important for success. However, achieving and maintaining such proficiency when repeatedly performing the athletic skill requires regular assessment and improvement of various biomechanics involved in performing the skill. Players often face challenges in improving their practice sessions and gameplay to hone these skills effectively. Existing technologies in the field of athletic performance analytics have attempted to address these challenges by providing feedback on a player's biomechanics. These technologies utilize AI or machine learning (ML) models that aggregate data from a wide range of players to predict athletic skill success and suggest adjustments to align with purported “ideal” biomechanics to perform the athletic skill. However, these approaches often fail to account for the specific biomechanics of individual players, and/or other characteristics of the player (including physical characteristics such as height, weight, lengths of arms, size of hands/feet, etc.) and/or associated with movement by the player (including speed, quickness, jumping ability, and so forth) that may influence biomechanics of the individual players, leading to recommendations that may not be optimal for all athletes. Additionally, the reliance on generalized data can result in feedback that does not accurately reflect the player's personal strengths and weaknesses, limiting their effectiveness. Embodiments described herein, aim to address these limitations by employing AI/ML to analyze a player's own shooting data, focusing on individual biomechanics and actual performance-of-skill success rates. By tracking and correlating various biomechanic metrics with success rates, one or more embodiments determine effective biomechanic adjustments in performing the athletic skill for the individual player. This personalized approach enables athletes to make informed decisions about performing the athletic skill, enhancing their performance by leveraging their personal strengths and providing insights based on data.

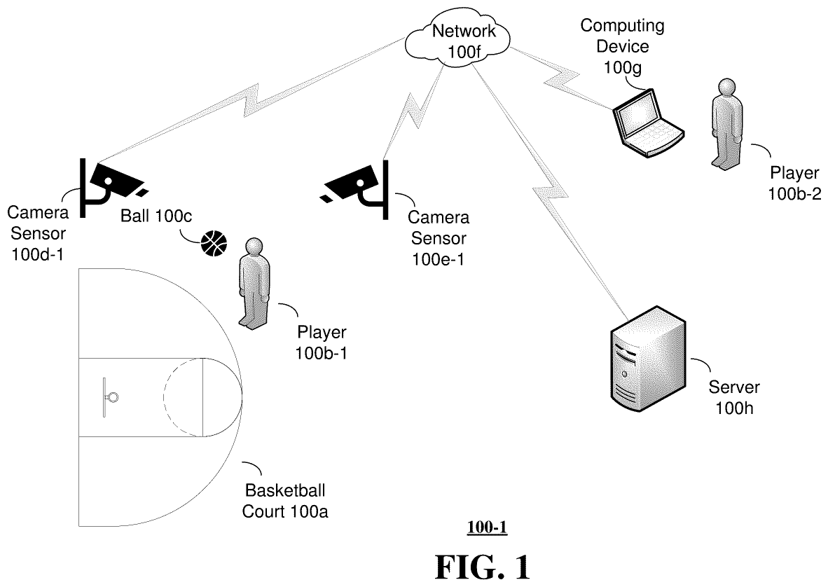

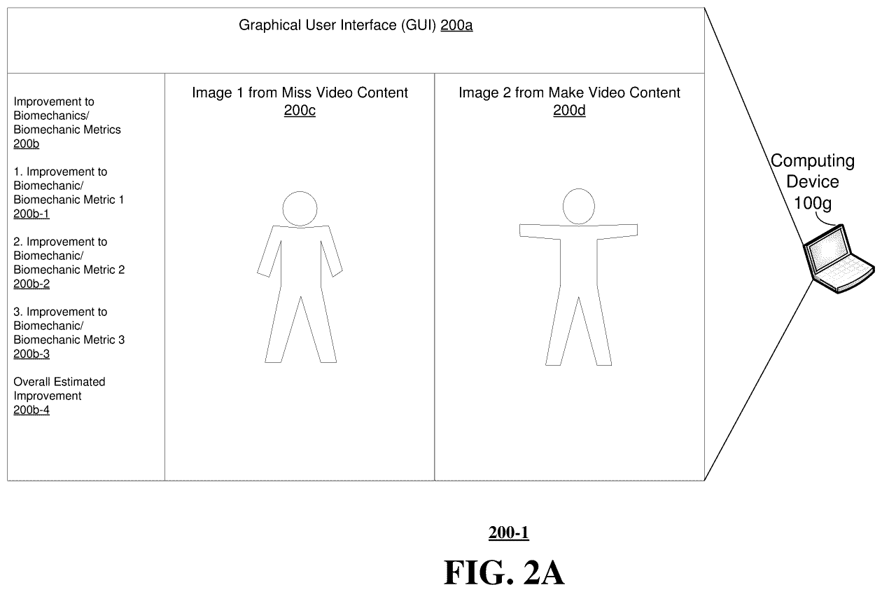

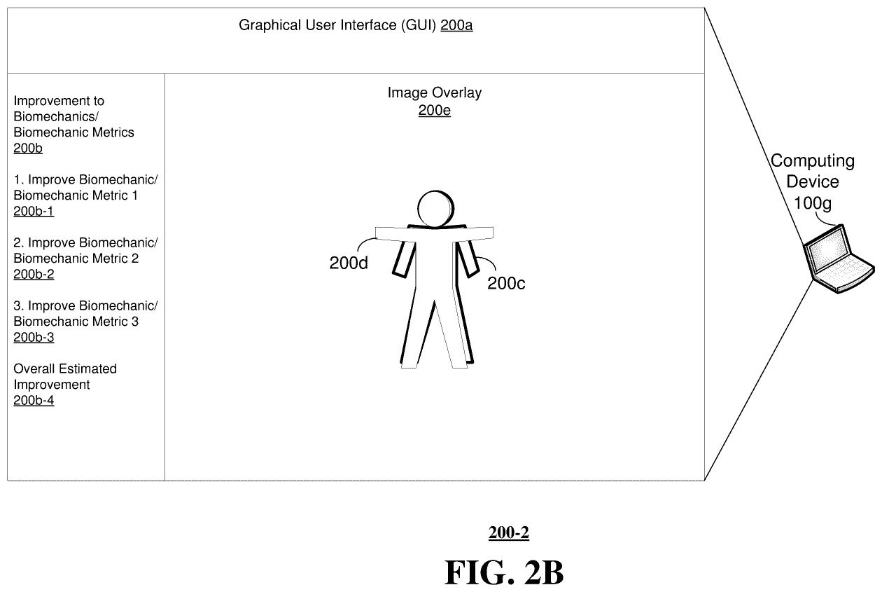

FIGS. 1-4 are block diagrams illustrating exemplary, non-limiting embodiments of a system to determine the biomechanics adjustment of a player to perform a skill in accordance with various aspects described herein. Referring to FIG. 1, in one or more embodiments, the system 100-1 comprises a basketball court 100a, where a player 100b-1, is engaged in shooting practice using basketball 100c. Further, the system 100 can include camera sensor 100d-1 and camera sensor 100e-1, which are strategically positioned around the basketball court 100a. In addition, the system 100 comprises a computing device 100g and a server 100h. Each of camera sensor 100d-1, camera sensor 100e-1, computing device 100g, and server 100h are communicatively coupled to one another via network 100f. Any number of camera sensors and any configuration can be utilized to facilitate of the operation of system 100-1.

In one or more embodiments, each of camera sensor 100d-1 and camera sensor 100e-1 can be a camera that can be remotely controlled by computing device 100g and/or server 100h. In further embodiments, each of camera sensor 100d-1 and camera sensor 100e-1 can include a smartphone camera, mobile device camera, a tablet camera, a digital camera, etc. In additional embodiments, position of each of camera sensor 100d-1 and camera sensor 100e-1 can be remotely controlled by computing device 100g and/or server 100h. In some embodiments, each of camera sensor 100d-1 and camera sensor 100e-1 can be moved laterally, radially, up and down, back and forth, and in any 360-degree direction. In some embodiments, each of camera sensor 100d-1 and camera sensor 100e-1 can be integrated in a system that can include computing device 100g and/or server 100h.

In one or more embodiments, network 100f can comprise one or more wired communication networks, one or more wireless communication networks, or a combination thereof. Further, computing device 100g can comprise a laptop computer, a desktop computer, a tablet computer, a smartphone, mobile phone, mobile device, a wearable device, a smartwatch or any other computing device, or combination thereof. In addition, server 100h can comprise one or more servers in one location, one or more servers spanning multiple locations, one or more virtual servers in one location, one or more virtual servers spanning multiple locations, one or more cloud servers, or combination thereof.

In one or more embodiments, player 100b-1 can perform an athletic skill such as shooting a basketball 100c on basketball court 100a. Further, each of camera sensor 100d-1 and camera sensor 100e-1 can capture real-time video content (e.g., images, video, video clips, etc.) of the movements of player 100b-1 and their biomechanics while performing their athletic skill (e.g., shooting basketball 100c). Biomechanics can include, but not limited to the mechanical, muscular, or movement associated with performing the athletic skill including a movement pattern associated with performing the athletic skill as well as the movement associated with the kinetic chain in performing the athletic skill. In some embodiments, each of camera sensor 100d-1 and camera sensor 100e-1 can be configured to maintain a fixed perspective relative to player 100b-1 and the basketball hoop of basketball court 100a, ensuring consistent pixel mapping for accurate analysis. The basketball 100c can be tracked, individually or collectively, by each of camera sensor 100d-1 and camera sensor 100e-1. In other embodiments, each of camera sensor 100d-1 and camera sensor 100e-1 can be mobile and move to track the movement of the basketball 100c during the shot from player 100b-1 to the basketball hoop and/or the movement of player 100b-1 themself. Further, each of camera sensor 100d-1 and camera sensor 100e-1 can record video content associated with player 100b-1 repeatedly performing the athletic skill (e.g., shooting basketball 100c) and determine whether the player successfully performed the athletic skill or not (e.g., making or missing the basketball shot) such that further components of system 100 can analyze each repetition of the athletic skill and interaction of the player's movements while performing each repetition.

In one or more embodiments, each of camera sensor 100d-1 and camera sensor 100e-1 can record video content of player 100b-1 while practicing performing of the athletic skill (e.g., shooting basketball 100c from 3-point range) during a practice session. A respective portion of this practice video content can be transmitted by each of camera sensor 100d-1 and camera sensor 100e-1 to computing device 100g and/or server 100h over network 100f. Further, an AI/ML software application on either computing device 100g or server 100h, described herein, can be configured to analyze the practice video content to determine a group of biomechanics and a group of biomechanic metrics for player 100b-1 associated with the repeated performance of the athletic skill (e.g., shooting basketball 100c). Further, the AI software application can determine a portion of the group of biomechanic metrics that provide success in performance of the athletic skill over an overall success rate (e.g., shooting basketball from 3-point range over 50%-overall shooting percentage and/or the shooting percentage for each shot type) for particular player 100b-1. Moreover, player 100b-2 can review the portion of the group of biomechanic metrics at computing device 100g to succeed in performing the athletic skill (e.g., shooting basketball 100c from 3-point range) during future gameplay.

In one or more embodiments, each of camera sensor 100d-1 and camera sensor 100e-1 can record video content of player 100b-1 while performing the athletic skill (e.g., shooting basketball 100c from 3-point range) during gameplay (subsequent to a training session). A respective portion of this game video content can be transmitted by each of camera sensor 100d-1 and camera sensor 100e-1 to computing device 100g and/or server 100h over network 100f. Further, the AI/ML software application on either computing device 100g or server 100h, described herein, can be configured to analyze the game video content to determine a group of biomechanic metrics for player 100b-1 associated with the repeated performance of the athletic skill (e.g., shooting basketball 100c) during gameplay. In one or more embodiments, the capturing of data and analysis as described herein, can be performed by system 100-1 in real-time or near-real-time (e.g., within a particular time threshold that allows for timely feedback to a player, such as right after a timeout which may be within less than a minute of the analyzed gameplay). Further, the AI/ML software application can determine a portion of the group of biomechanics and their associated biomechanic metrics that can be improved by particular player 100b-1 to be more successful in performing the athletic skill (e.g., shooting basketball from 3-point range). Moreover, player 100b-2 can review the portion of the group of biomechanics and their associated biomechanic metrics that they need to improve at computing device 100g during a break of gameplay (e.g. timeout, halftime, etc.). It should be understood that while system 100-1 is described with respect to the sport of basketball, the components and functionality associated with the system can be applied to various sports or activities where biometrics can be analyzed to improve performance.

Referring to FIG. 2A, in one or more embodiments, system 200-1 comprises a graphical user interface (GUI) 200a that can be displayed or presented on computing device 100g. In some embodiments, the GUI 200a (including any indications and images/video clips) therein can be generated by computing device 100g utilizing an AI/ML software application. In other embodiments, the information shown on GUI 200a (including any indications and images/video clips) therein can be generated by server 100h utilizing an AI/ML software application and subsequently transmitted to the computing device 100g to be presented by GUI 200a. In further embodiments, GUI 200a can include a list of improvements to or of biomechanics and their associated biomechanic metrics 200b, a first image 200c generated from miss video content (e.g., game video content), and a second image 200d generated from make video content (e.g., practice video content). Further, the list of improvements to biomechanics/biomechanic metrics 200b can include an improvement to biomechanic metric 1 200b-1, an improvement to biomechanic metric 2 200b-2, an improvement to biomechanic metric 3 200b-3, and an overall estimated improvement in performing the athletic skill 200b-4. It should be further understood that other number of images and improvements can be presented, and can be done so based on other categories of events, such as team practice, individual practice, and so forth.

In one or more embodiments, an example for performing an athletic skill can be shooting a basketball from 3-point range. Further, the example biomechanic to be improved can include pre-shot movement (e.g., biomechanic/biomechanic metric 1), jump direction (e.g., biomechanic/biomechanic metric 2), and landing stance (e.g., biomechanic/biomechanic metric 3). Moreover, analyzing the practice video content by the AI/ML software application can determine that player 100b-1 is successful in performing a basketball shot from 3-point range compared to the player's average success rate of the skill (e.g., 50%) when their pre-shot movement is towards the rim (improvement to biomechanic/biomechanic metric 1 200b-1) as opposed to moving left, moving right, moving away from the rim, or stationary; jump direction is slightly forward (improvement to biomechanic/biomechanic metric 2 200b-2) as opposed to straight up, considerably forward, left, right, or backwards; and landing stance to be shoulder width (improvement to biomechanic/biomechanic metric 3) as opposed to wide, staggered left, staggered right, or narrow. For example, for the biomechanic of pre-shot movement, the biomechanic metrics associated with this biomechanic can include the number of successful shots made when pre-shot movement is towards the rim (e.g., biomechanic) divided by the number of shots attempted (e.g., biomechanic metric=success rate). Another example can include the biomechanic of landing stance and the biomechanic metric can include the number of successful shots made when landing stance is shoulder width (e.g., biomechanic) divided by the number of shots attempted (e.g., biomechanic metric=success rate). The particulars or granularity for the biomechanics/biomechanic metrics can be at various levels, including generalized categories such as slightly forward vs. straight up vs. considerably forward, or can be more detailed such as 5-10 degrees forward vs. straight up, vs. greater than 10 degrees forward. Other biomechanic/biomechanic metrics including motion metrics can be tracked, analyzed, and indicated, including degrees of rotation for particular body parts (e.g., release/launch angle is less than 45 degrees as opposed to greater than 45 degrees), distance of body from each other (e.g., elbow positioned within 8 inches of chest, when shot is finished); and so forth. In one embodiments, weightings can be determined for different biomechanic/biomechanic metrics that indicate their influence on overall success rate in performing the athletic skill, such as determining that a wrist rotation of greater than 45 degrees in the follow-through after shooting the basketball has a larger impact on shot success than jumping direction that is forward X degrees. Further, the AI/ML software application can provide on the GUI 200a an overall estimated improvement 200b-4 (16.67%) such that if player 100b-1 is currently shooting 36% from 3-point range, they could possibly improve their shooting percentage to 42% if they implement all the biomechanic/biomechanic metric improvements.

In one or more embodiments, the second image 200d can be generated to be a composite image generated, by the AI/ML software application, from a group of images from the make video content that shows the movements of player 100b-1 when they previously implemented the biomechanic metric improvements (e.g., pre-shot movement is towards the rim, jump direction is slightly forward, and landing stance is shoulder width) in performing the athletic skill (e.g., shooting a basketball from 3-point range) compared to the player's average successful rate of the skill (e.g., 50%). In some embodiments, instead of generating the second image 200d, the AI/ML software application may generate a video clip that can be a composite from a group of images or portions of the make video content that shows the player 100b-1 performing the athletic skill with the biomechanic metric improvements.

In one or more embodiments, the first image 200c can be a composite image generated, by the AI/ML software application, from a group of images from the miss video content that shows the form of player 100b-1 when they are currently implementing the biomechanic metrics (e.g., pre-shot movement, jump direction, and landing stance) in performing the athletic skill (e.g., shooting a basketball from 3-point range) during game play. In some embodiments, instead of generating the first image 200c, the AI/ML software application may generate a video clip that can be a composite from a group of images or portions of the miss video content that shows the player 100b-1 performing the athletic skill with the biomechanic metrics.

In one or more embodiments, the player 100b-2 can view the GUI 200a including first image 200c and second image 200d side-by-side during a break in game play (e.g., halftime, timeout, etc.) to visually understand the way in which they are currently implementing the biomechanic/biomechanic metrics and the way in which they should improve each biomechanic/biomechanic metric accordingly.

Referring to FIG. 2B, in one or more embodiments, system 200-2 comprises GUI 200a that can be displayed or presented on computing device 100g. In some embodiments, the GUI 200a (including any indications and images/video clips) therein can be generated by computing device 100g utilizing an AI/ML software application. In other embodiments, the GUI 200a (including any indications and images/video clips) therein can be generated by server 100h utilizing an AI/ML software application. In further embodiments, GUI 200a can include a list of improvements of biomechanics/biomechanics metrics 200b, a first image 200c generated from miss video content, and a second image 200d generated from make video content. Further, the list of improvements to biomechanics/biomechanic metrics 200b can include a group of biomechanics/biomechanic metrics to improve include an improvement to biomechanic/biomechanic metric 1 200b-1, an improvement to biomechanic/biomechanic metric 2 200b-2, an improvement to biomechanic/biomechanic metric 3 200b-3, and an overall estimated improvement in performing the athletic skill 200b-4.

In one or more embodiments, an example for performing an athletic skill can be shooting a basketball from 3-point range. Further, the example biomechanic/biomechanic metrics to be improved can include pre-shot movement (e.g., biomechanic/biomechanic metric 1), jump direction (e.g., biomechanic/biomechanic metric 2), and landing stance (e.g., biomechanic/biomechanic metric 3). Moreover, analyzing the practice video content by the AI/ML software application can determine that player 100b-1 is successful in performing a basketball shot from 3-point range above a success rate (e.g., 50%) when their pre-shot movement is towards the rim (improvement to biomechanic/biomechanic metric 1 200b-1) as opposed to moving left, moving right, or moving away from the rim; jump direction is slightly forward (improvement to biomechanic/biomechanic metric 2 200b-2) as opposed to straight up, considerably forward, left, or right; and landing stance to be shoulder width (improvement to/biomechanic/biomechanic metric 3) as opposed to wide, staggered left, or staggered right. Further, the AI/ML software application can provide on the GUI 200a an overall estimated improvement 200b-4 (16.67%) such that if player 100b-1 is currently shooting 36% from 3-point range, they could possibly improve their shooting percentage to 42% if they implement all the biomechanic/biomechanic metric improvements.

In one or more embodiments, the second image 200d can be a composite image generated, by the AI/ML software application, from a group of images from the make video content that shows the form of player 100b-1 when they previously implemented the biomechanic/biomechanic metric improvements (e.g., pre-shot movement is towards the rim, jump direction is slightly forward, and landing stance is shoulder width) in performing the athletic skill (e.g., shooting a basketball from 3-point range) above a successful rate (e.g., 50%). In some embodiments, instead of generating the second image 200d, the AI/ML software application may generate a video clip that can be a composite from a group of images or portions of the make video content that shows the player 100b-1 performing the athletic skill with the biomechanic metric improvements.

In one or more embodiments, the first image 200c can be generated from miss video content as a composite image that is generated, by the AI/ML software application, from a group of images that shows the movements of player 100b-1 when they are currently implementing the biomechanic/biomechanic metrics (e.g., pre-shot movement, jump direction, and landing stance) in performing the athletic skill (e.g., shooting a basketball from 3-point range) during game play. In some embodiments, instead of generating the first image 200c, the AI/ML software application may generate a video clip that can be a composite from a group of images or portions of the miss video content that shows the player 100b-1 performing the athletic skill with the biomechanic/biomechanic metrics.

In one or more embodiments, the player 100b-2 can view the GUI 200a including first image 200c and second image 200d in an image overlay 200e during a break in game play (e.g., halftime, timeout, etc.) to visually understand the way in which they are currently implementing the biomechanic metrics and the way in which they should improve each biomechanic metric accordingly.

In one or more embodiments, the player 100b-2 can view the GUI with both the first image and second image to determine the biomechanic metrics they are currently performing during gameplay and the biomechanic metrics they need to perform to improve their performance of the athletic skill based on their own individual strengths discerned by the AI/ML software application analyzing the previous practice content. Moreover, multiple biomechanic metrics can be compiled together to determine which one of the biomechanics has the most significant impact (negative or positive) on the skill. That is, the AI/ML software application creates statistical correlation. In further embodiments, the GUI 200a can present only the biomechanic/biomechanic metric as performed by the player (e.g., from the game video content of practice video content) that can have the largest potential margin for improving their basketball shot. In additional embodiments, the AI/ML software application can generate video content or images of specific drills to improve weaknesses based on objective data from AI/ML analysis.

This allows for the player-100b-2 to make in-game adjustments to immediately improve their performance of the athletic skill instead of waiting for post-game analysis of the game content.

Referring to FIG. 3, in one or more embodiments, system 300 comprises several different components to analyze video content associated with a player performing an athletic skill to determine a group of biomechanics/biomechanic metrics to improve the performance of the athletic skill. Portions and/or the entirety of system 300 can be implemented by computing device 100g or by server 100h. Further, system 300 can comprise an image capture module 300a, an AI/ML software application 300b, a database 300c of AI/ML models, and/or a GUI software application 300d.

In one or more embodiments, the image capture module 300a can be a software application that acquires real-time video content of a player performing an athletic skill from camera sensor 100d-1 and/or camera sensor 100e-1. The AI/ML software application 300b can analyze the video content and determine a group of biomechanic metrics associated with the athletic skill to improve the performance of the athletic skill. In some embodiments, the AI/ML software application 300b can analyze the video content and determine the biomechanic metrics to analyze. In other embodiments, a user (e.g., player, coach, performance expert, etc.) can program or otherwise configure the AI/ML software application 300b with the biomechanics/biomechanic metrics to analyze. Further, the AI/ML software application can generate an image from currently acquired video content to show the player's biomechanics/biomechanic metrics to perform the skill as well as an image generated from previously acquired video content that shows the player's biomechanics/biomechanic metrics.

In one or more embodiments, prior to analyzing the video content, the AI/ML software application 300b can select one or more AI/ML models from the database 300c. In some embodiments, the AI/ML software application 300b can select the one or more AI/ML models based on the athletic skill being analyzed. In other embodiments, the one or more AI/ML models can be selected based on the available processor capacity and/or available memory capacity of the computing device 100g or server 100h implementing the AI/ML software application 300b.

In some embodiments, computing device 100g comprises system 300, and the GUI software application 300d can display the image generated from currently acquired video content as well as an image generated from previously acquired video content. In some embodiments, these images can be displayed simultaneously by the GUI software application side-by-side, as shown in FIG. 2A. In other embodiments, these images can be displayed simultaneously by the GUI software application overlayed on one another, as shown in FIG. 2B. In further embodiments, server 100h comprises system 300, and portions of the GUI software application 300d can span both server 100h and computing device 100g. The portion of GUI software application 300d on server 100h can provide the images to computing device 100g. In addition, the portion of GUI software application 300d on computing device 100g can display the images for the player to view, either side-by-side or overlayed.

Referring to FIG. 4, in one or more embodiments, the AI/ML software application (either on computing device 100g or server 100h) analyzing video content from camera sensor 100d-2 and camera sensor 100e-2 can determine that it cannot adequately analyze the performance of the athletic skill by player 100b-1 because of the position or orientation of camera sensor 100d-2 and camera sensor 100e-2. For example, neither camera sensor does not adequately capture video content of whether player 100b-1 makes or misses their basketball shot. In another example, neither camera sensor does not adequately capture video content of whether player 100b-1 performing the basketball shot or a biomechanic associated with performing the basketball shot. The AI/ML software application can provide instructions to each of camera sensor 100d-2 and camera sensor 100e-2 to adjust its respective position or orientation to have a better perspective in capturing video content of the player 100b-1 performing the athletic skill or recording/determining whether they successfully performed the athletic skill (e.g., successfully making the basketball shot or not). In some embodiments, the instructions to camera sensor 100d-2 can be to move to a higher location. In other embodiments, the instructions to camera sensor 100e-2 can be to adjust orientation to a different angle. Thus, at a different position (e.g., camera sensor 100d-2) and at a different angle/orientation (e.g., camera sensor 100e-2), the subsequently captured/acquired video content of the player performing the athletic skill can be analyzed by the AI/ML software application to determine any biomechanic/biomechanic metrics that can be improved. In one or more embodiments, the instructions and resulting adjustments for the camera sensor 100d-2 and camera sensor 100e-2 can be based on determination a particular biomechanic/biomechanic metric associated with the player that is to be captured (or is not being adequately captured) in order to improve the biomechanic assessment of the player, such as adjusting the orientation and/or position of one of the camera sensors to capture a particular view that shows the angle and/or separation distance between a player's feet when they are on the floor (before jumping), in air (when shot is being released) and back on the floor (when they land after shooting). In one or more embodiments, application of the AI/ML software application to manage or otherwise control the camera sensor 100d-2 and/or camera sensor 100e-2 (e.g., position, orientation, resolution, frame speed, lighting, contrast, and so forth) can provide efficiency in performing the biomechanic assessment of the player, such as ensuring or attempting to ensure that the best possible metrics or data is being captured. The efficiency can also be improved in some embodiments based on remote control of the function, orientation, and positioning of the camera sensor 100d-2 and/or camera sensor 100e-2 that eliminates the need for user interaction with the equipment, which can be a slower process resulting a reduction as to the amount of properly captured data (e.g., from a new camera sensor position or new orientation), such as during a live basketball game.

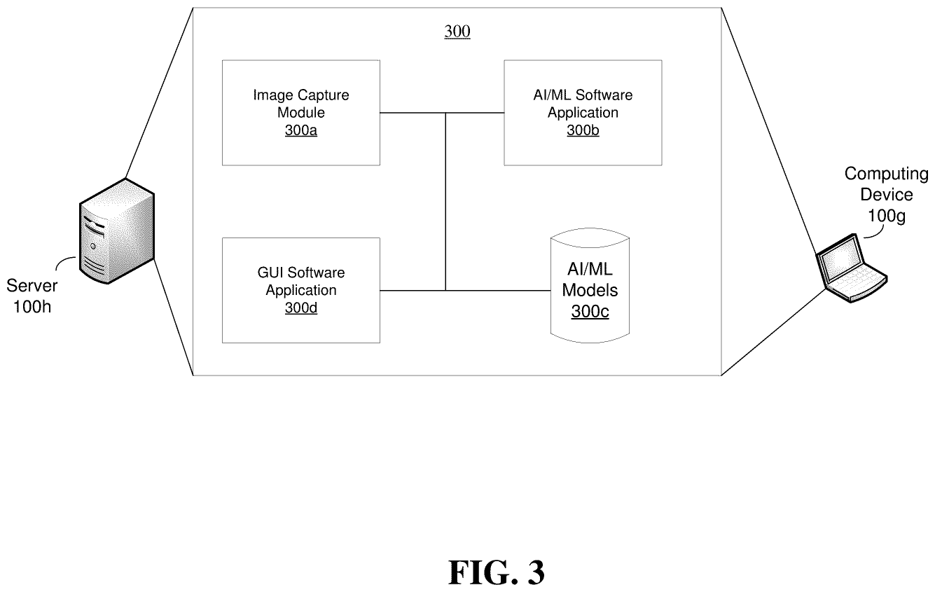

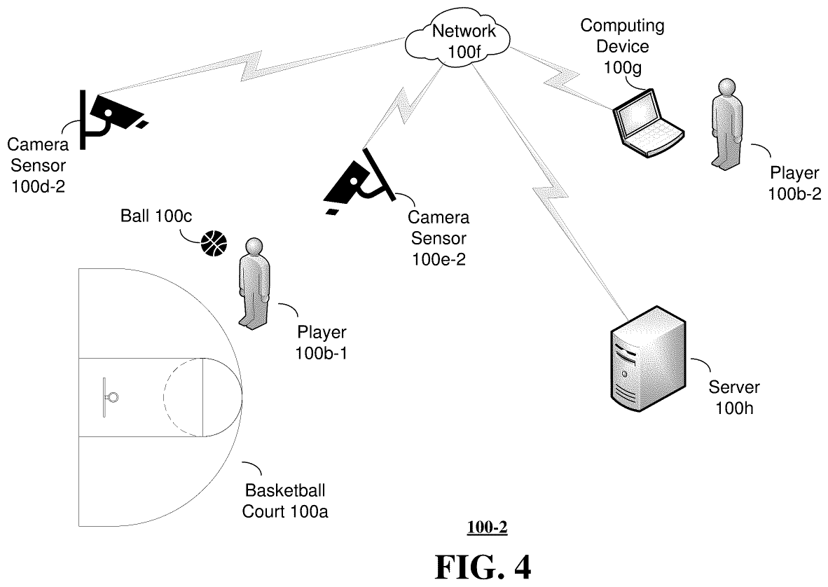

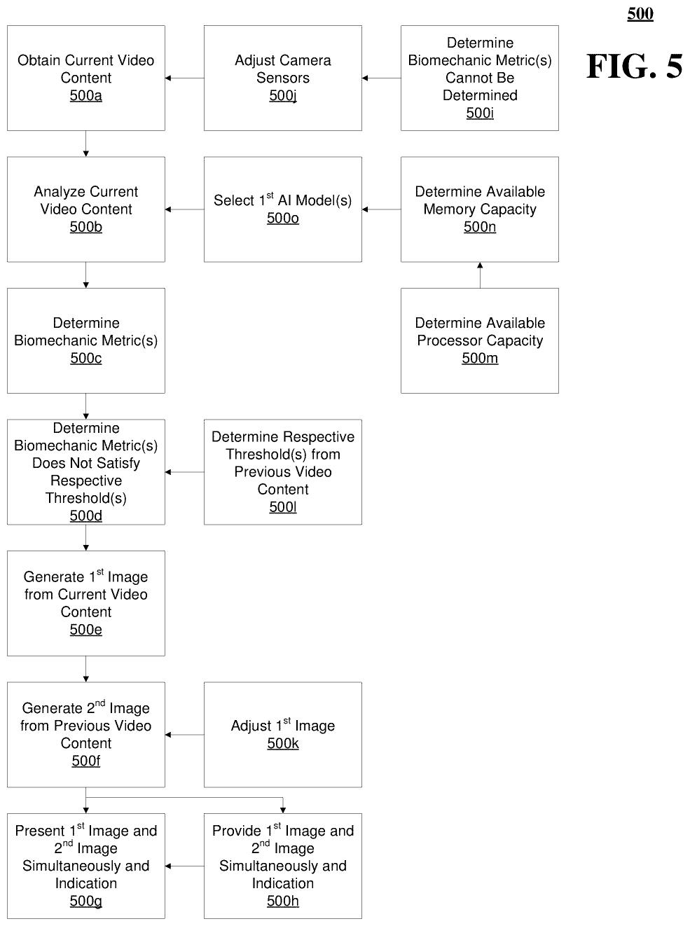

FIG. 5 depicts an illustrative embodiment of a method 500 in accordance with various aspects described herein. Aspects of method 500 can be performed by a computing device and/or server. The method 500 can include the computing device or server, at 500a, obtaining video content of a player repeatedly performing a physical skill during a first time period resulting in current video content. Further, the method 500 can include the computing device or server, at 500b, analyzing the current video content utilizing an AI/ML software application based on previous video content resulting in an analysis. The previous video content comprises other video content of the player repeatedly performing the physical skill during a second time period. The second time period is prior to the first time period. In addition, the method 500 can include the computing device or server, at 500c, determining a group of biomechanic metrics associated with the player performing the physical skill based on the analysis utilizing the AI/ML software application resulting in a first determination. Also, the method 500 can include the computing device or server, at 500d, based on the first determination, determining each biomechanic metric of a portion of the group of biomechanic metrics does not satisfy a respective biomechanic metric success rate from a group of respective biomechanic metric success rates resulting in a second determination.

In one or more embodiments, the method 500 can include the computing device or server, at 500e, based on the second determination, generating a first image of the player performing the physical skill from the current video content. Further, the method 500 can include the computing device or server, at 500f, based on the second determination, generating a second image of the player performing the physical skill from the previous video content. In some embodiments, the method 500 can include the computing device, at 500g, presenting the first image and the second image simultaneously on the device with an indication of the portion of the group of biomechanics that did not satisfy the respective biomechanic metric success rate. In other embodiments, the method 500 can include the server, at 500h, providing the first image and the second image to a computing device over a communication network. The computing device presents the first image and the second image simultaneously on the computing device with an indication of the portion of the group of biomechanics that did not satisfy the respective biomechanic metric success rate. In additional embodiments, the presenting of the first image and the second image simultaneously on the device comprises presenting the first image and the second image side-by-side. In further embodiments, the presenting of the first image and the second image simultaneously on the device comprises presenting the second image overlaid onto the first image. In some embodiments, instead of a first image generated from current video content or a second image generated from previous video content, a first video clip can be generated from current video content and a second video clip can generated from previous video content. Further, both the first video clip and the second video clip can be provided to the GUI application on the computing device to be presented to a player simultaneously, side-by-side or overlayed.

In one or more embodiments, the method 500 can include the computing device or server, at 500k, adjusting the first image based on the portion of the group of biomechanics. In some embodiments, the generating the second image comprises adjusting the first image based on the portion of the group of biomechanics. In some embodiments, generating of the second video clip can comprise adjusting the first video clip based on the portion of the group of biomechanics.

In one or more embodiments, the recording of the video content of the player repeatedly performing the physical skill during the first time period can be done with a group of camera sensors. Each of the group of camera sensors are at a respective first position. Further, the method 500 can include the computing device or server, at 500i, determining that the group of biomechanic metrics cannot be determined from a portion of the current video content utilizing the AI/ML software application resulting in a third determination. In addition, the method 500 can include the computing device or server, at 500j, based on the third determination, adjusting a portion of the group of camera sensors from the respective first position to a respective second position. The adjusting a portion of the group of camera sensors can include providing instructions to each of the group of camera sensors that indicate to change their respective position or orientation (any 360-degree adjustment of position, up and down, laterally, or back and forth).

In one or more embodiments, the method 500 can include the computing device or server, at 500l, determining the group of respective biomechanic metric success rates from the previous video content utilizing the AI/ML software application. For example, in shooting a basketball from 3-point range, one biomechanic can be pre-shot movement. Further, the biomechanic metrics for this biomechanic can include left, right, towards the rim, away from the rim, or stationary. Moreover, the AI/ML software application can determine that the player is most successful in making a basketball shot from 3-point range when they conduct pre-shot movement towards the rim. That is, the player makes a shot from 3-point range 78% of the time when their pre-shot movement is towards the rim. Thus, the biomechanic metric success rate for pre-shot movement towards the rim is 78%. In another example, another biomechanic can be jump direction. The biomechanic metric for this biomechanic can include straight up, slightly forward, considerably more forward, left, right, and backwards. Moreover, the AI/ML software application can determine that the player is most successful in make a basketball shot from 3-point range when they conduct a jump straight up. That is, the player makes a shot from 3-point range 74.1% (e.g., biomechanic metric success rate) of the time when they jump straight up. In a further example, a further biomechanic can be landing stance. The biomechanic metric for this biomechanic can include shoulder width, wide, staggered left, staggered right, and narrow. Moreover, the AI/ML software application can determine that the player is most successful in making a basketball shot from 3-point range when they set their landing stance shoulder width. That is, the player makes a shot from 3-point range 77.1% (e.g., biomechanic metric success rate) of the time when they set their landing stance shoulder width.

In one or more embodiments, the method 500 can include the computing device or server, at 500m, determining available processing capacity of the processing system resulting in a fourth determination. In addition, the method 500 can include the computing device or server, at 500n, determining available memory capacity of the memory resulting in a fifth determination. Also, the method 500 can include the computing device or server, at 500o, based on the fourth determination and the fifth determination, selecting the first group of AI/ML models from a second group of AI/ML models.

In one or more embodiments, the physical skill comprises a basketball shot and the group of biomechanic/biomechanic metrics can include shot type, shot preparation, pre-shot movement, footwork, toes pointed, stance, group of release time, reception of pass, pass details, landing knees, eye gaze, jump direction, landing stance, landing feet, landing movement, follow through, follow through details, wrist, guide hand, discipline, result, and swish.

In one or more embodiments, the physical skill or athletic skill can comprise not only a basketball shot, but also, but not limited to, passing a basketball, defending a basketball player, blocking a basketball shot, shooting a soccer ball, passing a soccer ball defending a soccer player, saving a soccer ball by goalkeeper, throwing a football, catching a football, blocking in football, tacking in football, kicking a football, punting a football, swing a bat in baseball, catching a baseball, pitching in baseball, sliding in baseball, skating in hocket, shooting in hockey, passing in hockey, checking in hockey, defending in hockey, saving a puck by a goalkeeper in hockey, swing a tennis racquet, swinging a golf club, or performing any other physical skill or athletic skill.

While for purposes of simplicity of explanation, the respective processes are shown and described as a series of blocks in FIG. 5, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. In some embodiments, one or more blocks can be performed in response to one or more other blocks.

Portions of some embodiments can be combined with portions of other embodiments.

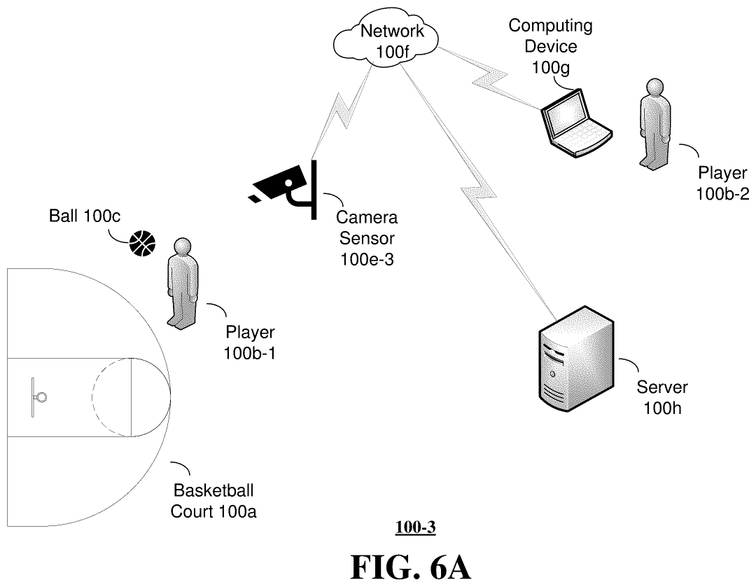

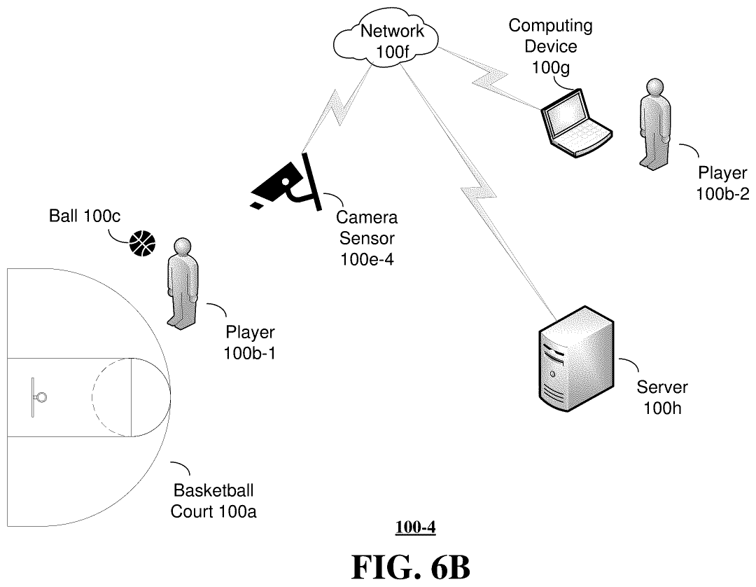

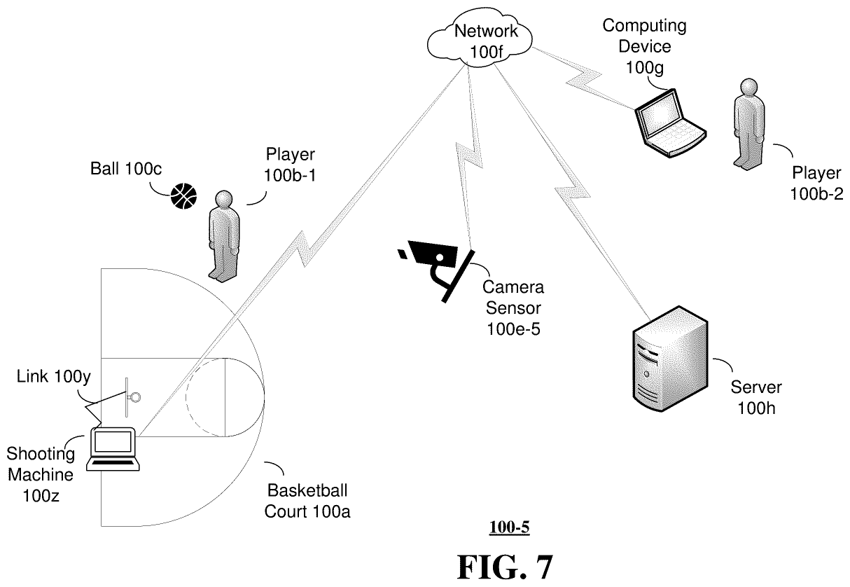

Referring to FIG. 6A, in one or more embodiments, system 100 includes a basketball court 100a, player 100b-1 shooting a basketball 100c, a camera sensor 100e-3 positioned/oriented to recording image content or video content of player 100b-1 shooting basketball 100c. Further, camera sensor 100e-3 is communicatively coupled to computing device 100g, and server 100h over communication network 100f. Thus, system 100-3 can include all the components of system 100-1 but instead of system 100-1 including two cameras, namely camera sensor 100d-1 and camera sensor 100e-1, system 100-3 includes only one camera, namely camera sensor 100e-3.

In one or more embodiments, camera sensor 100e-3 is positioned/oriented such that it records player 100b-1 shooting the ball 100c at the basket and records whether player 100b-1 successfully shoots the ball 100c or does not successfully shoot the ball (e.g., to later determine the success rate). In further embodiments, the computing device 100g can obtain video content of a player 100b-1 repeatedly performing shooting a basketball 100c during gameplay resulting in current video content utilizing camera sensor 100e-3. The camera sensor 100e-3 is oriented in a first position. In some embodiments, prior to analyzing the current video content, an AI software application implemented on either computing device 100g or server 100h can determine that a group of biomechanics/biomechanic metrics cannot be determined from a portion of the current video content resulting in a determination. Further, based on the determination, the computing device 100g or the server 100h can provide instructions to the camera sensor 100e-3 to adjust the camera sensor 100e-3 from the first position to a second position. That is, upon analyzing the current video content, the AI software application determines that it cannot record the entire body of the players 100b-1 while taking a shot and record whether the player 100b-1 successfully made the shot. Based on the determination, the computing device 100g can adjust or provide instructions to the camera sensor to adjust from the first position to a second position, as shown in FIG. 6B.

In one or more embodiments, upon analyzing the current video content, the AI software application can determine that it can record the entire body of the players 100b-1 while taking a shot and record whether the player 100b-1 successfully made the shot. Further, computing device 100g can analyze the current video content utilizing the AI software application based on previous video content resulting in an analysis. The previous video content comprises other video content of the player repeatedly making a shot during a second time period. The second time period is prior to the first time period. In addition, the computing device 100g can determine a group of biomechanic metrics associated with the player performing the basketball shot based on the analysis utilizing the AI software application resulting in a determination. Also, based on the determination, determining each biomechanic metric of a portion of the group of biomechanic metrics does not satisfy a respective biomechanic metric success rate from a group of respective biomechanic metric success rates resulting in another determination. Based on this other determination, generating a first image of the player 100b-1 shooting the basketball 100c from the current video content. Further, based on this other determination, generating a second image of the player 100b-1 shooting the basketball 100c from the previous video content. In addition, the computing device 100g can present the first image and the second image simultaneously on the computing device 100g with an indication of the portion of the group of biomechanics that did not satisfy the respective biomechanic metric success rate.

In one or more embodiments, the generating the second image by computing device 100g comprises adjusting the first image based on the portion of the group of biomechanics by the computing device 100g. In addition, the presenting of the first image and the second image simultaneously on the computing device 100g comprises presenting the first image and the second image side-by-side. Also, the presenting of the first image and the second image simultaneously on computing device 100g can comprise presenting the second image overlaid onto the first image. In some embodiments, computing device 100g can determine the group of respective biomechanic metric success rates from the previous video content utilizing the AI software application.

In one or more embodiments, camera 100e-3 can be focused on, and capturing images of, player 100b-1 while they are shooting basketball 100c and camera 100e-3 may not be focused on, and not capturing images of the rim to determine whether the basketball shot attempted by player 100b-1 has been made or missed. Instead, in some embodiments, a sensor (e.g., motion sensor, movement sensor, image sensor, etc.) can be coupled to, in communication with, or otherwise associated with the rim to determine whether the attempted basketball shot has been made or missed. In further embodiments, the sensor can be communicatively coupled with computing device 100g and/or server 100h to provide data indicating whether a group of attempted basketball shots are made or missed. In addition, camera sensor 100e-3 can provide captured images of player 100b-1 shooting the basketball for each attempted basketball shot Further, the AI/ML software application on either computing device 100g and/or server 100h can analyze the captured images as well as the sensor data to determine the number/percentage of makes or misses associated with the group of basketball shots as well as identify the images that associated with the made basketball shots and the images associated with the missed basketball shots. These images can be displayed to the player 100b-2 so as they can review the biomechanics associated with the missed basketball shots as well as the biomechanics associated with made basketball shots and improve accordingly.

Referring to FIG. 7, in one or more embodiments, system 100-5 includes a basketball court 100a, player 100b-1 shooting a basketball 100c, a camera sensor 100e-5 positioned/oriented to recording image content or video content of player 100b-1 shooting basketball 100c. Further, camera sensor 100e-5 and shooting machine 100z are communicatively coupled to computing device 100g, and server 100h over communication network 100f. In addition, the shooting machine 100z can be communicatively to the basketball hoop on basketball court 100c via communication link 100y. Thus, system 100-3 can include all the components of system 100-1 but instead of system 100-1 including two cameras, namely camera sensor 100d-1 and camera sensor 100e-1, system 100-3 includes only one camera, namely camera sensor 100e-3. Moreover, the system 100-5 can include shooting machine 100z.

In one or more embodiments, system 100-5 that utilizes an AI software application on either computing device 100g or server 100h to analyze video content received from camera sensor of player 100b-1 shooting basketball 100c to determine the player's success rate and provide any information to improve the success rate. However, while system 100-1 includes two camera sensors, one camera sensor recording the player shooting the basketball and another camera sensor recording whether the basketball shot was a success or not (e.g., can be used to determine the success rate), system 100-5 includes one camera sensor 100e-5 recording the player 100b-1 shooting the basketball and the shooting machines 100z determining whether the basketball shot was a success or not utilizing one or more sensors in proximity to the basketball hoop (e.g., sensor data can be used to determine success rate).

In one or more embodiments, computing device 100g can obtain video content of player 100b-1 repeatedly performing a physical skill (e.g., shooting a basketball) during a first time period resulting in current video content utilizing camera sensor 100e-5. The camera sensor is oriented in a first position. Further, computing device 100g can obtain sensor data from a physical skill practice machine (e.g., shooting machine 100z). The sensor data indicates correctly performing and incorrectly performing the physical skill repeatedly (e.g., success rate of shooting the basketball 100c). In addition, the computing device 100g can analyze the current video content and the sensor data utilizing an AI software application based on previous video content resulting in an analysis. The previous video content comprises other video content of the player repeatedly performing the physical skill (e.g., shooting the basketball 100c) during a second time period. The second time period is prior to the first time period. Also, the computing device 100g can determine a group of biomechanic metrics associated with the player performing the physical skill (e.g., shooting the basketball 100c) based on the analysis utilizing the AI software application resulting in a first determination.

In one or more embodiments, based on the first determination, computing device 100g can determine each biomechanic metric of a portion of the group of biomechanic metrics does not satisfy a respective biomechanic metric success rate from a group of respective biomechanic metric success rates resulting in a second determination. Further, based on the second determination, computing device 100g can generate a first image of the player performing the physical skill (e.g., the shooting of basketball 100c) from the current video content. In addition, based on the second determination, computing device 100g can generate a second image of the player performing the physical skill (e.g., shooting basketball 100c) from the previous video content. Also, the computing device 100g can present the first image and the second image simultaneously on the device with an indication of the portion of the group of biomechanics that did not satisfy the respective biomechanic metric success rate.

In one or more embodiments, the generating, by the computing device 100g, the second image comprises adjusting, by the computing device 100g, the first image based on the portion of the group of biomechanics. In other embodiments, the presenting of the first image and the second image simultaneously on the computing device 100g comprises presenting the first image and the second image side-by-side. In further embodiments, the presenting of the first image and the second image simultaneously on the device comprises presenting the second image overlaid onto the first image. Further, the computing device 100g, can determine the group of respective biomechanic metric success rates from the previous video content utilizing the AI software application.

In one or more embodiments, the server 100h can provide the same functions as computing device 100g described herein and provide the first image and second image to the computing device 100g over network 100f such that computing device 100g can present the first image and the second image simultaneously, side-by-side or overlaid.

Referring to FIG. 8, in one or more embodiments, system 100-6 includes a basketball court 100a, player 100b-1 shooting a basketball 100c, a camera sensor 100e-6 positioned/oriented to recording image content or video content of player 100b-1 shooting basketball 100c. Further, camera sensor 100e-3 is communicatively coupled to computing device 100g, and server 100h over communication network 100f. Thus, system 100-3 can include all the components of system 100-1 but instead of system 100-1 including two cameras, namely camera sensor 100d-1 and camera sensor 100e-1, system 100-3 includes only one camera, namely camera sensor 100e-3. In addition, system 100-6 includes a speaker to record audio content spoken by player 100b-1.

In one or more embodiments, system 100-6 utilizes an AI software application on either computing device 100g or server 100h to analyze video content received from camera sensor of player 100b-1 shooting basketball 100c to determine the player's success rate and provide any information to improve the success rate. However, while system 100-1 includes two camera sensors, one camera sensor recording the player shooting the basketball and another camera sensor recording whether the basketball shot was a success or not (e.g., can be used to determine the success rate), system 100-5 includes one camera sensor 100e-5 recording the basketball shot performed by the player 100b-1 and player 100b-1 speaking on whether each basketball shot is a success or not. In some embodiments, player 100b-1 can say “make” to indicate that a basketball shot was a success and player 100b-1 can say “miss” to indicate that a basketball shot was not a success. Further, such audio content spoken by player 100b-1 can be recorded by speaker 100x and provide to computing device 100g to be analyzed by the AI software application.

In one or more embodiments, the computing device 100g can obtain video content of player 100b-1 repeatedly performing a physical skill (e.g., shooting a basketball) during a first time period resulting in current video content utilizing camera sensor 100e-6. Further, camera sensor 100e-6 is oriented in a first position. In addition, computing device 100g can obtain voice input from player 100b-1, via speaker 100x, utilizing voice recognition techniques or technology. The voice input indicates correctly performing and incorrectly performing the physical skill (shooting basketball) repeatedly. Also, computing device 100g can analyze the current video content and the voice input utilizing an AI software application based on previous video content resulting in an analysis. The previous video content comprises other video content of the player repeatedly performing the physical skill (e.g., shooting basketball) during a second time period. The second time period is prior to the first time period.

In one or more embodiments, computing device 100g can determine a group of biomechanic metrics associated with the player performing the physical skill (e.g., shooting basketball) based on the analysis utilizing the AI software application resulting in a first determination. Further, based on the first determination, computing device 100g can determine each biomechanic metric of a portion of the group of biomechanic metrics does not satisfy a respective biomechanic metric success rate from a group of respective biomechanic metric success rates resulting in a second determination. In addition, based on the second determination, computing device 100g can generate a first image of player 100b-1 performing the physical skill (e.g., shooting a basketball) from the current video content. In addition, based on the second determination, computing device 100g can generate a second image of player 100b-1 performing the physical skill (e.g., shooting the basketball) from the previous video content. Also, the computing device 100g can present the first image and the second image simultaneously on computing device 100g to player 100b-2 with an indication of the portion of the group of biomechanics that did not satisfy the respective biomechanic metric success rate.

In one or more embodiments, the generating of the second image comprises adjusting the first image based on the portion of the group of biomechanics. Further, the presenting of the first image and the second image simultaneously on the computing device 100g comprises presenting the first image and the second image side-by-side. In addition, the presenting of the first image and the second image simultaneously on the computing device 100g comprises presenting the second image overlaid onto the first image. Also, computing device 100g can determine the group of respective biomechanic metric success rates from the previous video content utilizing the AI software application.

In one or more embodiments, the server 100h can provide the same functions as computing device 100g described herein and provide the first image and second image to the computing device 100g over network 100f such that computing device 100g can present the first image and the second image simultaneously, side-by-side or overlaid.

In one or more embodiments, instead of speaking “make” or “miss” to indicate whether player 100b-1 has made an attempted basketball shot or missed an attempted basketball shot, player 100b-1 can make a first hand signal (e.g., thumbs up) or can make a second hand signal (e.g., thumbs down). The image of the first hand signal or the second hand signal can be captured by camera sensor 100d-6 and the images associated with the first hand signals and the second hand signals can be provided to computing device 100g and/or server 100h. Further, the AI/ML software application can analyze the biomechanics associated with a portion of the basketball shots and associated the biomechanics with the first hand signal and determine that the associated basketball shots are made basketball shots. In addition, the AI/ML software application can analyze the biomechanics associated with another portion of the basketball shots and associated the biomechanics with the second hand signal and determine that the associated basketball shots are missed basketball shots, and can provide images of their biomechanics accordingly via computing device 100g, thereby providing recommendations for improvement to player 100b-2.

In one or more embodiments, instead of speaking “make” or “miss” to indicate whether player 100b-1 has made a basketball shot or missed a basketball shot, player 100b-1 can make a first clapping sound (e.g., two claps) or can make a second clapping sound (e.g., one clap). The audio of the first clapping sound or the second clapping sound can be captured by speaker 100x and the associated audio content can be provided to computing device 100g and/or server 100h, thereby generating a group of audio content. Further, the AI/ML software application can analyze the biomechanics associated with the shooting the basketball and with the audio content of the first clapping signal and determine that the associated basketball shots are made basketball shots. In addition, the AI/ML software application can analyze the biomechanics associated with the shooting the basketball and associated audio content of the second hand signal and determine that the associated basketball shots are missed basketball shots, and can provide images of their biomechanics accordingly via computing device 100g to improve the basketball shot of player 100b-2 accordingly.

In one or more embodiments, player 100b-1 can have a mobile device (e.g., a smartwatch, mobile phone, tablet computer, etc.) that includes a mobile application associated with the AI/ML software application on the computing device 100g and/or server 100h. The mobile device can provide a tactile interface (e.g., a touchscreen, switch, button, dial, etc.) such that player 100b-1 can provide first user-generated input (e.g., touching a first icon on the mobile application) to indicate a made basketball shot and can provide a second user-generated input (e.g., touching a second icon on the mobile application) indicate a missed basketball shot. The group of user-generated input associated with the group of basketball shots that indicate made basketball shots and missed basketball shots can be provided to the AI/ML software application on either computing device 100g and/or server 100h. Further, the AI/ML software application can analyze the images provided by camera sensor 100e-6 to either computing device 100g or server 100h for biomechanics associated with the shooting the basketball with the group of user-generated input (or a portion thereof associated with the first user-generated input) to determine that the associated basketball shots are made basketball shots. In addition, the AI/ML software application can analyze the images provided by camera sensor 100e-6 to either computing device 100g or server 100h for the biomechanics associated with the shooting the basketball with the group of user-generated input (or a portion thereof associated with the second user-generated input) to determine that the associated basketball shots are missed basketball shots, and can provide images of their biomechanics accordingly via computing device 100g to improve the basketball shot of player 100b-2.

Referring to FIG. 9, in one or more embodiments, system 100-7 includes a basketball court 100a, player 100b-1 shooting a basketball 100c, a camera sensor 100d-7 positioned/oriented to recording image content or video content of player 100b-1 shooting basketball 100c and a camera sensor 100e-7 positioned/oriented to recording image content or video content that the basketball shot was a success or not. Further, camera sensor 100d-7 and camera sensor 100e-7 are communicatively coupled to computing device 100g, and server 100h over communication network 100f.

In one or more embodiments, system 100-6 utilizes an AI software application on either computing device 100g or server 100h to analyze video content received from camera sensor of player 100b-1 shooting basketball 100c to determine the player's success rate and provide any information to improve the success rate. However, AI software application executing on computing device 100g can provide a gamification practice session. That is, the AI software application can provide a graphical user interface (GUI) on computing device 100g multiple simulated gameplay scenarios. In some embodiments, each simulated gameplay scenario can be depicted by a shot chart 100w. In further embodiments, the multiple simulated gameplay scenarios can be generated by analyzing stored video content of a player practicing shooting a basketball and determining that each simulated gameplay scenario can improve a biomechanic metric associated with shooting the basketball. In addition, the player 100b-2 can select, via user-generated input, one of the multiple simulated gameplay scenarios and display an associated shot chart 100w, accordingly. In some embodiments, the shot chart 100w can comprise an animated shot chart that animates through each shot in the shot chart 100w. In other embodiments, the animated shot chart presents an indication of each of the group of basketball shots via animation

In one or more embodiments, player 100b-1 can perform a practice session for shooting a basketball according to the shot chart 100w and camera sensor 100d-7 as well as camera sensor 100e-7 can record the practice session accordingly. Further, the recorded content can be provided to computing device 100g for analysis by the AI software application to determine any improvements for shooting the basketball by player 100b-1 and provide suggest the improvements accordingly.

In one or more embodiments, computing device 100g can provide GUI on computing device 100g that presents a group of simulated gameplay scenarios to player 100b-2. Further, the computing device 100g can receive user-generated input from the GUI as provided player 100b-2. The user-generated input indicates a first simulated gameplay scenario from the group of simulated gameplay scenarios. In addition, the computing device 100g can present the first simulated gameplay scenario on the GUI to the player 100b-2.

In one or more embodiments, computing device 100g can obtain current video content of the player repeatedly performing a physical skill (e.g., shooting basketball) during a first time period according to the first simulated gameplay scenario resulting in current video content. A portion of the video content can be from camera sensor 100d-7 and another portion of the video content can be from camera sensor 100e-7. Further, the computing device 100g can analyze the current video content utilizing an AI software application based on previous video content resulting in an analysis. The previous video content comprises other video content of the player repeatedly performing the physical skill (e.g., shooting a basketball) during a second time period. The second time period is prior to the first time period. In addition, the computing device 100g can determine a group of biomechanic metrics associated with the player performing the physical skill based on the analysis utilizing the AI software application resulting in a first determination. Also, based on the first determination, the computing device 100g can determine each biomechanic metric of a portion of the group of biomechanic metrics does not satisfy a respective biomechanic metric success rate from a group of respective biomechanic metric success rates resulting in a second determination. Further, based on the second determination, the computing device 100g can determine a second simulated gameplay scenario from the group of simulated gameplay scenarios utilizing the AI software application. The second simulated gameplay scenario improves a first biomechanic metric of the portion of the group of biomechanic metrics. In addition, the computing device 100g can present the second simulated gameplay scenario on the GUI to the player.

In one or more embodiments, based on the second determination, computing device 100g can determine a first biomechanic associated with the first biomechanic metric resulting in a third determination. Further, based on the third determination, the computing device 100g can identify a portion of the previous video content associated with the first biomechanic. In addition, the computing device 100g can present the portion of the previous video content on the GUI to the player to indicate how to improve the success rate of performing the physical skill (e.g., shooting the basketball).

In one or more embodiments, the presenting of the portion of the previous video content comprises presenting the portion of the previous video content on the GUI simultaneously with presenting the second simulated gameplay scenario on the GUI. Further, the computing device 100g can determine the group of respective biomechanic metric success rates from the previous video content utilizing the AI software application.

In one or more embodiments, the server 100h can provide the same functions as computing device 100g described herein. For example, the server 100h can generate the multiple simulated gameplay scenarios and provide them to the computing device 100g to be presented on a GUI on computing device 100g to player 100b-2.

In one or more embodiments, the AI software application on either computing device 100g or server 100h can provide mobile application on a mobile device (e.g., smart watch, mobile phone, tablet computer, etc.) with a shot chart 100w. In further embodiments, the shot chart 100w can be part of a gamification embodiment of the AI software application. The gamification embodiment can include a computer-generated opponent that makes or misses the same or similar shots as the shot chart 100w. The computer-generated opponent can simulate a real professional, college, or other player. Further, the gamification embodiments can include an increasing level of difficulty of shot within the shot chart 100w as the basketball player 100b-1 progress along the shot chart 100w. In some embodiments, the AI software application can keep track of a won/loss record of player 100b-1 for each game played against such a computer-generated opponent. In further embodiments, the AI software application can keep track the won/loss record of games of player 100b-1 played against a computer-generated opponent or a group of computer-generated opponents that can correspond to a simulated season of games. The AI software application can receive captured data (e.g., image data, audio content, user-generated input, etc.), as described herein, of the makes and misses of the basketball shots attempted by the player 100b-1 according to the shot chart 100w. Further, the AI software application can provide improvements and adjustments of the biomechanics of player 100b-1 as described herein accordingly.

Note, embodiments that describe an AI software application can also utilize an ML software application to provide the same or similar functions as the AI software application. Further, embodiments that describe an ML software application can also utilize an AI software application to provide the same or similar functions as the ML software application.

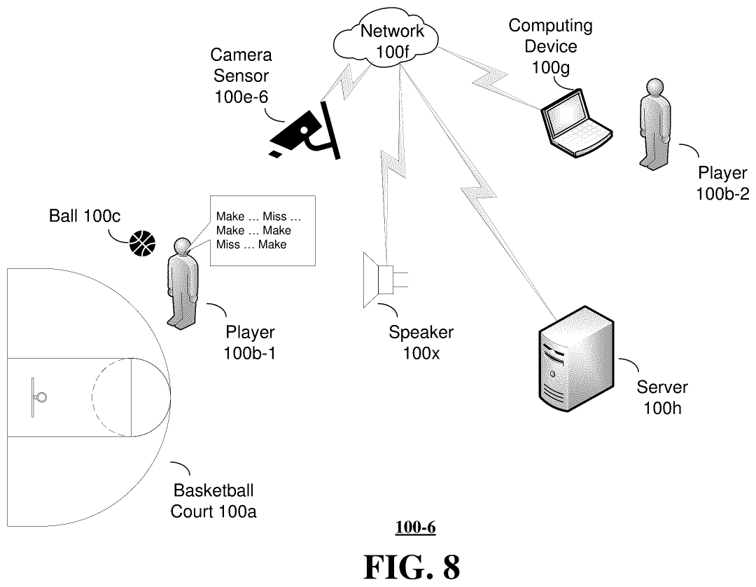

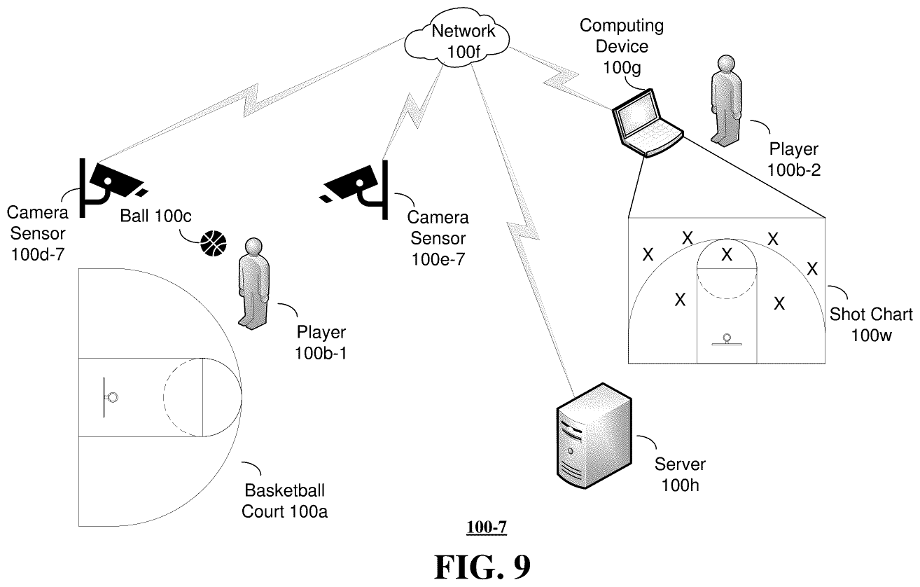

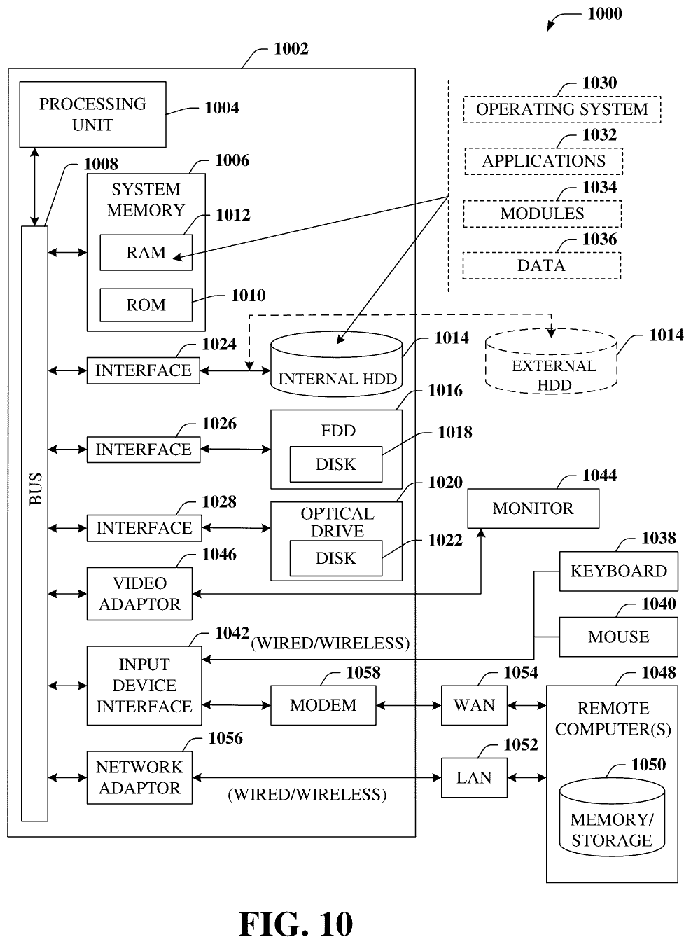

Turning now to FIG. 10, there is illustrated a block diagram of a computing environment in accordance with various aspects described herein. In order to provide additional context for various embodiments of the embodiments described herein, FIG. 10 and the following discussion are intended to provide a brief, general description of a suitable computing environment 1000 in which the various embodiments of the subject disclosure can be implemented. For example, computing environment 1000 can facilitate in whole or in part capturing video content of a player repeatedly performing an athletic skill to be analyzed to determine biomechanic adjustments to improve performance of the athletic skill. Each of camera sensor 100d-1, camera sensor 100e-1, camera sensor 100d-2, camera sensor 100e-2, camera sensor 100e-3, camera sensor 100e-4, camera sensor 100e-5, shooting machine 100z, speaker 100x, computing device 100g, and server 100h can comprise aspects of computing environment 1000.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices (including a phone), microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 10, the example environment can comprise a computer 1002, the computer 1002 comprising a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multiprocessor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 comprises ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also comprise a high-speed RAM such as static RAM for caching data.

The computer 1002 further comprises an internal hard disk drive (HDD) 1014 (e.g., EIDE, SATA), which internal HDD 614 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high-capacity optical media such as the DVD). The HDD 1014, magnetic FDD 1016 and optical disk drive 1020 can be connected to the system bus 1008 by a hard disk drive interface 1024, a magnetic disk drive interface 1026 and an optical drive interface 1028, respectively. The hard disk drive interface 1024 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1012, comprising an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can comprise a microphone, an infrared (IR) remote control, a joystick, a game pad, a stylus pen, touch screen or the like. These and other input devices are often connected to the processing unit 1004 through an input device interface 1042 that can be coupled to the system bus 1008, but can be connected by other interfaces, such as a parallel port, an IEEE 1394 serial port, a game port, a universal serial bus (USB) port, an IR interface, etc.

A monitor 1044 or other type of display device can be also connected to the system bus 1008 via an interface, such as a video adapter 1046. It will also be appreciated that in alternative embodiments, a monitor 1044 can also be any display device (e.g., another computer having a display, a smart phone, a tablet computer, etc.) for receiving display information associated with computer 1002 via any communication means, including via the Internet and cloud-based networks. In addition to the monitor 1044, a computer typically comprises other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically comprises many or all of the elements described relative to the computer 1002, although, for purposes of brevity, only a remote memory/storage device 1050 is illustrated. The logical connections depicted comprise wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the LAN 1052 through a wired and/or wireless communication network interface or adapter 1056. The adapter 1056 can facilitate wired or wireless communication to the LAN 1052, which can also comprise a wireless AP disposed thereon for communicating with the adapter 1056.

When used in a WAN networking environment, the computer 1002 can comprise a modem 1058 or can be connected to a communications server on the WAN 1054 or has other means for establishing communications over the WAN 1054, such as by way of the Internet. The modem 1058, which can be internal or external and a wired or wireless device, can be connected to the system bus 1008 via the input device interface 1042. In a networked environment, program modules depicted relative to the computer 1002 or portions thereof, can be stored in the remote memory/storage device 1050. It will be appreciated that the network connections shown are example and other means of establishing a communications link between the computers can be used.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device. comprising:
a processing system including a processor; and
a memory that stores executable instructions that, when executed by the processing system, facilitate performance of operations, the operations comprising:
obtaining video content of a player repeatedly performing a physical skill during a first time period resulting in current video content;
analyzing the current video content utilizing an AI software application based on previous video content resulting in an analysis, wherein the previous video content comprises other video content of the player repeatedly performing the physical skill during a second time period, wherein the second time period is prior to the first time period;
determining a group of biomechanic metrics associated with the player performing the physical skill based on the analysis utilizing the AI software application resulting in a first determination;
based on the first determination, determining each biomechanic metric of a portion of the group of biomechanic metrics does not satisfy a respective biomechanic metric success rate from a group of respective biomechanic metric success rates resulting in a second determination;
based on the second determination, generating a first image of the player performing the physical skill from the current video content;
based on the second determination, generating a second image of the player performing the physical skill from the previous video content; and
presenting the first image and the second image simultaneously on the device with an indication of the portion of the group of biomechanics that did not satisfy the respective biomechanic metric success rate.

2. The device of claim 1, wherein the generating the second image comprises adjusting the first image based on the portion of the group of biomechanics.

3. The device of claim 1, wherein the presenting of the first image and the second image simultaneously on the device comprises presenting the first image and the second image side-by-side.

4. The device of claim 1, wherein the presenting of the first image and the second image simultaneously on the device comprises presenting the second image overlaid onto the first image.

5. The device of claim 1, wherein the obtaining of the video content of the player repeatedly performing the physical skill during the first time period resulting in the current video content comprises recording the video content of the player repeatedly performing the physical skill during the first time period with a group of camera sensors, wherein each of the group of camera sensors are at a respective first position.

6. The device of claim 5, wherein the operations comprise:
determining that the group of biomechanic metrics cannot be determined from a portion of the current video content utilizing the AI software application resulting in a third determination; and
based on the third determination, adjusting a portion of the group of camera sensors from the respective first position to a respective second position.

7. The device of claim 1, wherein the operations comprise determining the group of respective biomechanic metric success rates from the previous video content utilizing the AI software application.

8. The device of claim 1, wherein the physical skill comprises a basketball shot.

9. The device of claim 8, wherein the group of biomechanic metrics is selected from shot type, shot preparation, pre-shot movement, footwork, toes pointed, stance, group of release time, reception of pass, pass details, landing knees, eye gaze, jump direction, landing stance, landing feet, landing movement, follow through, follow through details, wrist, guide hand, discipline, result, and swish.

10. The device of claim 1, wherein the AI software application implements a first group of AI models, wherein the operations comprise:
determining available processing capacity of the processing system resulting in a fourth determination;
determining available memory capacity of the memory resulting in a fifth determination; and
based on the fourth determination and the fifth determination, selecting the first group of AI models from a second group of AI models.

11. A non-transitory, machine-readable storage device, comprising executable instructions that, when executed by a processing system including a processor, facilitate performance of operations comprising:
obtaining video content of a player repeatedly performing a physical skill during a first time period resulting in current video content;
analyzing the current video content utilizing an AI software application based on previous video content resulting in an analysis, wherein the previous video content comprises other video content of the player repeatedly performing the physical skill during a second time period, wherein the second time period is prior to the first time period;
determining a group of biomechanic metrics associated with the player performing the physical skill based on the analysis utilizing the AI software application resulting in a first determination;
based on the first determination, determining each biomechanic metric of a portion of the group of biomechanic metrics does not satisfy a respective biomechanic metric success rate from a group of respective biomechanic metric success rate resulting in a second determination;
based on the second determination, generating a first image of the player performing the physical skill from the current video content;
based on the second determination, generating a second image of the player performing the physical skill from the previous video content; and
providing the first image and the second image to a computing device over a communication network, wherein the computing device presents the first image and the second image simultaneously on the computing device with an indication of the portion of the group of biomechanics that did not satisfy the respective biomechanic metric success rate.

12. The non-transitory, machine-readable storage device of claim 11, wherein the generating the second image comprises adjusting the first image based on the portion of the group of biomechanics.

13. The non-transitory, machine-readable storage device of claim 11, wherein the operations comprise providing first instructions to the computing device to present the first image and the second image simultaneously on the computing device with the first image and the second image side-by-side.

14. The non-transitory, machine-readable storage device of claim 11, wherein the operations comprise providing second instructions to the computing device to present the first image and the second image simultaneously on the computing device with the second image overlaid onto the first image.

15. The non-transitory, machine-readable storage device of claim 11, wherein the physical skill comprises a basketball shot.

16. The non-transitory, machine-readable storage device of claim 15, wherein the group of biomechanic metrics is selected from shot type, shot preparation, pre-shot movement, footwork, toes pointed, stance, group of release time, reception of pass, pass details, landing knees, eye gaze, jump direction, landing stance, landing feet, landing movement, follow through, follow through details, wrist, guide hand, discipline, result, and swish.

17. A method, comprising:
obtaining, by a processing system including a processor, video content of a player repeatedly performing a physical skill during a first time period resulting in current video content utilizing a group of camera sensors, wherein each camera sensor of the group of camera sensors are oriented in a respective first position;
determining, by the processing system, that a group of biomechanic metrics cannot be determined from a portion of the current video content utilizing an AI software application resulting in a first determination;
based on the first determination, adjusting, by the processing system, a portion of the group of camera sensors from the respective first position to a respective second position;
analyzing, by the processing system, the current video content utilizing the AI software application based on previous video content resulting in an analysis, wherein the previous video content comprises other video content of the player repeatedly performing the physical skill during a second time period, wherein the second time period is prior to the first time period;
determining, by the processing system, the group of biomechanic metrics associated with the player performing the physical skill based on the analysis utilizing the AI software application resulting in a second determination;
based on the second determination, determining, by the processing system, each biomechanic metric of a portion of the group of biomechanic metrics does not satisfy a respective biomechanic metric success rate from a group of respective biomechanic metric success rates resulting in a third determination;
based on the third determination, generating, by the processing system, a first image of the player performing the physical skill from the current video content;
based on the third determination, generating, by the processing system, a second image of the player performing the physical skill from the previous video content; and
presenting, by the processing system, the first image and the second image simultaneously on the processing system with an indication of the portion of the group of biomechanics that did not satisfy the respective biomechanic metric success rate.

18. The method of claim 17, wherein the generating the second image comprises adjusting, by the processing system, the first image based on the portion of the group of biomechanics.

19. The method of claim 17, wherein the presenting of the first image and the second image simultaneously on the processing system comprises presenting, by the processing system, the first image and the second image side-by-side.

20. The method of claim 17, wherein the presenting of the first image and the second image simultaneously on the processing system comprises presenting, by the processing system, the second image overlaid onto the first image.
